(19) United States
(12) Patent Application Publication
(10) Pub. No.: US 2026/0314645 A1
(43) Pub. Date: Oct. 15, 2026

(54) AN EDIBLE HYDROGEL, METHOD OF PRODUCTION AND USES THEREOF

(71) Applicant: Redefine Meat Ltd., Rehovot (IL)

(72) Inventors: Shmuel ITTAH, Mevaseret Zion (IL); Jonathan HAUSNER, Kefar Saba (IL); Yael PRIGAT GOLDFRIEND, Tel Aviv (IL); Moran COHEN, Be'er Ya'akov (IL); Daniel DIKOVSKY, Ariel (IL); Nissim DAVID, Netivot (IL); Eshchar BEN-SHITRIT, Nataf (IL)

(21) Appl. No.: 18/685,437

(22) PCT Filed: Aug. 29, 2022
(86) PCT No.: PCT/IL2022/050933

§ 371 Date: Feb. 21, 2024

(30) Foreign Application Priority Data
Aug. 30, 2021 (IL) 285958

(51) Int. Cl. A23L 29/256; A23J 3/22

(52) U.S. Cl. CPC A23L 29/256; A23J 3/227

(57) ABSTRACT

The present disclosure provides an edible hydrogel comprising carrageenan (CAR) and an aqueous carrier comprising water wherein said water constitutes up to 80 wt % out of a total volume of the hydrogel; and wherein, when said hydrogel has between 50 wt % and 80 wt % water content, the hydrogel is characterized by (a) CAR content of at least 5 wt % out of a total volume of the hydrogel; (b) a storage modulus (G1) of at least 1 OKPa within a temperature range of 25° C.-70° C.; (c) tensile strength of at least 600 kPa as determined at 25° C.; and (d) tensile strain at break of at least 15% as determined at 25° C. Also provided are methods of obtaining the dibble hydrogel and uses thereof.

### TECHNOLOGICAL FIELD

The technology relates to the food industry.

### BACKGROUND ART

References considered to be relevant as background to the presently disclosed subject matter are listed below:
Xi Yang, Anqi Li, Xiuxiu Li, Lijun Sun, Yurong Guo An overview of classifications, properties of food polysaccharides and their links to applications in improving food textures Trends in Food Science & Technology 102 (2020) 1-15.
Zhi Yang, Huijuan Yang, Hongshun Yang, Characterisation of rheology and microstructures of κ-carrageenan in ethanol-water mixtures. Food Research International 107 (2018) 738-746;
Lingyan Kong and Gregory R Ziegler Fabrication of κ-Carrageenan Fibers by Wet Spinning: Spinning Parameters Materials 4 (2011) 1805-1817;
M. R. Mangione, D. Giacomazza, D. Bulone, V. Martorana, G. Cavallaro, P. L. San Biagio K+ and Na+ effects on the gelation properties of κ-Carrageenan Biophysical Chemistry 113 (2005) 129-135
Bakti B. Sedayu, Marlene J. Cran, Stephen W. Bigger. A Review of Property Enhancement Techniques for Carrageenan-based Films and Coatings. Carbohydrate Polymers. 216 (2019) 287-302;
Korean Patent Application No. 20120015783
International Patent Application Publication No. WO2014/176304
International Patent Application Publication No. WO0248199
US Patent Application Publication No. US2004/0052839
International Patent Application Publication No. WO01/03677
International Patent Application Publication No. WO2018/227656
Chinese Patent Application Publication No. 112430290
   Acknowledgement of the above references herein is not to be inferred as meaning that these are in any way relevant to the patentability of the presently disclosed subject matter.

### BACKGROUND

Xi Lang (2020) discusses the classification and properties of food polysaccharides and their use in improving the textural attributes of a wide range of food products, including emulsion-based foods, low calorie foods, restructured foods, gelatin free foods, breaded or battered foods, and frozen foods as well as wheaten foods.

Zhi Yang (2017) describes the effect of ethanol on the properties of carrageenan-based gels. It was found that the thermoreversibility of κ-carrageenan gel was affected by ethanol addition; the gelling and melting temperature increased with increasing ethanol; the fractal dimension and gel strength increased upon ethanol addition, and a denser and thicker fibril network was formed upon ethanol addition.

Lingyan Kong (2011) describe the fabrication of discrete (not film) κ-carrageenan fibers by a wet-spinning method involving the use of ethanol and the effect of the latter on the ultimate stress and break elongation of the as-spun fibers.

KR20120015783 describes a non-edible hydrogel composition for transdermal absorption and administration that provides adhesion and high tensile strength and provides skin moisturizing and skin hydration. The hydrogel comprises galactomannan gum, carrageenan gum and tackifiers. The amount of carrageenan gum is between 0.5% to 10% by weight based on the total amount of the hydrogel composition.

WO2014/176304 describes a method of forming a non-edible hybrid physically and chemically cross-linked double-network hydrogel with recoverable and mechanical properties in a single-pot synthesis. The hydrogel comprises, inter alia, a polysaccharide selected from agar, gelatin, sodium alginate, carrageenan, and others. The hydrogel exhibited high stiffness (elastic modulus of 123 kPa), strength (failure compression stress of 38 MPa and failure tensile stress of 1.0 MPa) dissipated energy (9 MJ/m³), extensibility (15-20 times longer relative to its initial length), and a free-shapeable property (formation of many complex geometrical shapes).

WO0248199 describes processes for preparing carrageenan-containing products from processed seaweed using shear stress. Films can be formed, for example, by casting a carrageenan containing solution on a cooled rotating drum. Optionally, the carrageenan-containing film can be fed through a series of rollers to counter rotating dies which form, cut, and fill capsules of various sizes.

US2004/0052839 describes a method of producing a non-gelatin film, the method includes combining at least one non-gelatin hydrocolloid, water, and at least one plasticizer into a substantially homogeneous film-forming composition comprising at least about 40% water by weight. The method further includes extracting a portion of the water from the film-forming composition to form a dried portion having a water content of less than or equal to about 25% by weight. The method also includes forming the dried portion of the film-forming composition into a film. The film exhibited a tensile strength at rupture of at least about 5 N at room temperature, a percent elongation of at least about 50 percent at rupture at room temperature.

WO01/03677 describes compositions comprising modified starch and carrageenan, especially iota-carrageenan, the compositions being suitable for use in manufacturing soft capsules.

WO2018/227656 describes an edible film forming liquid and preparation thereof. The edible film comprising marine polysaccharides fish collagen protein and glycerol.

CN112430290 describes kappa-carrageenan-based high strength crosslinked hydrogel.

### GENERAL DESCRIPTION

The present disclosure provides, in accordance with a first of its disclosed aspects, an edible hydrogel comprising carrageenan (CAR) and an aqueous carrier comprising water;
wherein said water constitutes up to 80 wt % out of a total volume of the hydrogel;
   and
wherein, when said hydrogel has between 50 wt % and 80 wt % water content, the hydrogel is characterized by
CAR content of at least 5 wt % out of a total volume of the hydrogel;
storage modulus (G′) of at least 10 KPa within a temperature range of 25° C.-70° C.; and
tensile strength at least 600 kPa as determined at 25° C.; and
tensile strain at break of at least 15% as determined at 25° C.

Also provided by a second aspect of the presently disclosed subject matter a method of producing an edible hydrogel, the method comprises treating a native hydrogel comprising at least 5 wt % CAR within an aqueous medium, said treatment comprises subjecting the native hydrogel to a dehydration process until obtaining a dehydrated hydrogel with up to 50 wt % liquid content; and rehydrating the dehydrated hydrogel by exposing the dehydrated hydrogel to a rehydrating medium.

In accordance with a third aspect of the presently disclosed subject matter there is provided a further method of producing an edible hydrogel, the method comprises treating a native hydrogel comprising at least 5 wt % CAR and an aqueous medium, said treatment comprises subjecting the native hydrogel to an anti-solvent system to obtain a solidifying native hydrogel; and subjecting the solidifying native hydrogel to a dehydration process until obtaining a dehydrated hydrogel with up to 50 wt % liquid content. The dehydrated hydrogel can be stored and subjected to rehydration, as presently disclosed, prior to intended consumption.

The present disclosure also provides, in accordance with a fourth aspect of the presently disclosed subject matter, an edible hydrogel obtained or obtainable by the method of the second aspect of the presently disclosed subject matter.

In accordance with a fifth aspect of the present disclosed subject matter, there is provided a food product comprising the edible hydrogel disclosed herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a Thermogravimetric Analysis (TGA) of different carrageenan-based films.

### DETAILED DESCRIPTION

The present disclosed subject matter is based on the realization by the inventors that there is a need to enrich meat analogue products with texture enhancers in addition to or as alternative to texturized proteins hitherto used (e.g. texturized vegetable proteins (TVP), high moisture extruded (HME) proteins, fibrous gluten), so as to improve the toughness and chewiness experience by the individuals when eating the meat analogues.

It has been further realized by the inventors that while polysaccharide gels are good candidates, they still require modifications to comply with improved mechanical and rheological properties required/desired for a meat analogue.

It has been yet further realized by the inventors that not all polysaccharides are suitable and that there is a need for specific conditions, such as type of polysaccharide and concentration (e.g. minimal amount or range) of polysaccharide, to obtain a polysaccharide-based texture enhancer that fits the desired characteristic of the end product, as further detailed hereinbelow.

Thus, in accordance with a first aspect of the presently disclosed subject matter, there is provided an edible hydrogel comprising carrageenan (hereinbelow “CAR”) and an aqueous carrier comprising water,
wherein said water constitutes up to 80 wt % out of a total volume of the hydrogel;
   and
wherein when said hydrogel has between about 50 wt % and about 80 wt % water, the hydrogel is characterized by
   CAR content of at least 5 wt % out of a total volume of the hydrogel;
   a storage modulus (G′) of at least 10 KPa within a temperature range of 25° C.-70° C.;
   a tensile strength of at least 600 KPa as determined 25° C. by a tensile strength test,
   a tensile strain at break of at least 15% as determined by a tensile test at 25° C.

It is to be appreciated that there are different techniques to determine physical properties of a product.

In some examples, storage modulus of a sample can be determined in a test performed on discs of 40 mm in diameter and 1 mm thick, and analyzed by Rheometer (Discovery HR20, TA) using 40 mm stainless steel, sandblasted parallel plates, during which each film was subjected to Grips axial force (1N), oscillation strain of 10%, and frequency of 10 Hz. The tested temperature range can be 25° C.-70° C.

In some examples, tensile properties (specifically, tensile strain and/or tensile strength) can be determined using TA1 Series Texture Analysis machine (LLOYD TA1), using a load cell of 100N with TG74: adjustable Rear Face Vice Grip 5 kN-1124 lbf. Test speed was 20 mm/sec.

The test was applied on different film samples (CAR, Gellan, Agar, Alginate), each containing different concentrations of the hydrogel polymer in water (e.g. 3%, 5%, 7%, 9%, as examples only), the film having either a height of 100 mm (50 mm gauge), a width of 20 mm and a thickness of 1 mm (referred to herein as Sample Type 1) or on a sample prepared according to ASTM D638 Type 1 (Sample Type 2).

In the context of the present disclosure, when referring to an edible hydrogel it is to be understood as including only edible components, i.e. components that are or could be recognized as food or acceptably used in food products, and/or acceptable as food safe. In other words, the edible hydrogel cannot include substances that may be considered toxic or unsafe for human consumption.

The edible hydrogel can have different levels of water.

In some examples of the presently disclosed subject matter, the hydrogel is a dehydrated hydrogel. According to the dehydrated hydrogel aspect, the edible hydrogel comprises up to 50 wt % liquid, preferably water; at times the dehydrated hydrogel comprises up to 40 wt % or at times up to 30 wt %; at times between about 5 wt % and 40 wt %; at times, between about 5 wt % and about 35 wt %. It is to be understood, in the context of the presently disclosed subject matter, that the dehydrated hydrogel comprises some amount of liquid, i.e. it cannot be completely (0%) without water.

In some examples of the presently disclosed subject matter, the edible hydrogel is a rehydrated hydrogel, comprising at least 50 wt % water but not more than 80 wt %. interestingly, it has been found that when rehydrated from a dehydrated state, the amount of liquid (e.g. a rehydration medium/composition) in the rehydrated hydrogel cannot return to the level that could have been present in the hydrogel before dehydration. The rehydrated hydrogel is semi-solid, having a pliable, dough-like texture.

Further, interestingly, and without being bound by theory, it has been found that the process of dehydration followed by rehydration improves the rheological properties of the hydrogel as compared to the native hydrogel (the one obtained by dissolving the hydrogel forming material in an aqueous medium).

The hydrogel comprises, at minimum, carrageenan (CAR) and an aqueous medium, typically water based.

The hydrogel is dehydrated or rehydrated, may comprise minerals, salts, polymers and other components, in addition to the CAR and water, some of which may be considered as insignificant/inert impurities. The additional components may originate from the source of the CAR and/or be introduced to the hydrogel during its production as will be further explained below.

In some examples, the hydrogel comprises other hydrogel forming agents, in addition to CAR. In some examples, the other hydrogel forming agent is selected from agar, gelatin, sodium alginate, Gellan Gum, Pectin, Xanthan Gum, Guar Gum, Methylcellulose, Starch, Konjac, Locust Bean Gum, Tara Gum, Curdlan and Chitosan and combinations of same. When CAR is combined with other hydrogel forming agents, the CAR constitutes at least 5 wt % out of the total hydrogel, irrespective of the amount of the other hydrogel forming agents present in the hydrogel.

In some examples the addition included a combination of the at least 5% CAR with glycerin.

In some examples, the addition included a combination of the at least 5% CAR with Gellan.

In some examples, the addition included a combination of the at least 5% CAR with glycerin and Gellan.

In some examples, the hydrogel consists essentially or consists of only CAR as the hydrogel forming agent.

As defined above, the hydrogel of the presently disclosed subject matter comprises at least CAR.

The term Carrageenan refers to a family of hydrophilic biopolymers made up of β-(1,3) sulfated υ-galactose and α-(1,4)-3,6-anhydro-υ-galactose residues. These are linear sulfated polysaccharides. There are three basic naturally occurring carrageenan types: Iota Carrageenan (ι-Carrageenan), Kappa Carrageenan (κ-Carrageenan) and Lambda Carrageenan (λ-Carrageenan).

In the context of the present disclosure, when referring to CAR, it is to be understood to include also animal-free functional analogue thereof, as those known in the industry.

In accordance with the presently disclosed subject matter, when referring to CAR, it is to be understood to encompass at least κ-CAR or a κ-CAR functional analogue. When referring to CAR functional analogue it is to be understood to encompass a hydrophilic sulfated polysaccharide that is capable of being formed into a hydrogel.

In some examples, CAR functional analogue comprises galactose as the monosaccharide unit.

In some examples, the CAR functional analogue is a modified form of a naturally occurring CAR, the modification being exhibited by a different location or amount of ester sulfated groups along the polysaccharide molecule.

In some other examples, the CAR functional analogue is one that is cross linked with other polymers e.g. other polysaccharides.

Further, in accordance with some examples of the presently disclosed subject matter, when referring to CAR, it is to be understood to exclude or essentially exclude iota-CAR.

In some examples, the edible hydrogel comprises more than 50% κ-CAR out of the total amount of hydrogel forming agents. In some examples, the edible hydrogel comprises more than 60% κ-CAR out of the total amount of hydrogel forming agents. In some examples, the edible hydrogel comprises more than 70% κ-CAR out of the total amount of hydrogel forming agents. In some examples, the edible hydrogel comprises more than 80% κ-CAR out of the total amount of hydrogel forming agents. In some examples, the edible hydrogel comprises more than 90% κ-CAR out of the total amount of hydrogel forming agents. In some examples, the edible hydrogel comprises essentially only κ-CAR out of the total amount of hydrogel forming agents therein.

The hydrogel comprises at least 5 wt % CAR out of the total weight of the hydrogel.

In some examples, the hydrogel comprises at least 6 wt % CAR out of the total weight of the hydrogel. In some examples, the hydrogel comprises at least 7 wt % CAR out of the total weight of the hydrogel. In some examples, the hydrogel comprises at least 8 wt % CAR out of the total weight of the hydrogel. In some examples, the hydrogel comprises at least 9 wt % CAR out of the total weight of the hydrogel. In some examples, the hydrogel comprises at least 10 wt % CAR out of the total weight of the hydrogel. In some examples, the hydrogel comprises at least 11 wt % CAR out of the total weight of the hydrogel. In some examples, the hydrogel comprises at least 12 wt % CAR out of the total weight of the hydrogel. In some examples, the hydrogel comprises at least 13 wt % CAR out of the total weight of the hydrogel. In some examples, the hydrogel comprises at least 14 wt % CAR out of the total weight of the hydrogel.

In some examples, the hydrogel comprises at most about 15 wt % CAR out of the total weight of the hydrogel. In some examples, the hydrogel comprises at most about 14 wt % CAR out of the total weight of the hydrogel. In some examples, the hydrogel comprises at most about 13 wt % CAR out of the total weight of the hydrogel. In some examples, the hydrogel comprises at most about 12 wt % CAR out of the total weight of the hydrogel. In some examples, the hydrogel comprises at most about 10 wt % CAR out of the total weight of the hydrogel.

In some examples, the hydrogel comprises between 5 wt % and 15 wt % CAR out of the total weight of the hydrogel. In some examples, the hydrogel comprises between 6 wt % and 15 wt % CAR out of the total weight of the hydrogel. In some examples, the hydrogel comprises between 7 wt % and 15 wt % CAR out of the total weight of the hydrogel. In some examples, the hydrogel comprises between 8 wt % and 15 wt % CAR out of the total weight of the hydrogel. In some examples, the hydrogel comprises between 9 wt % and 15 wt % CAR out of the total weight of the hydrogel.

In addition to CAR, the hydrogel comprises an aqueous carrier. In some examples, the aqueous carrier comprises water and at least one additional component, the additional component being any one of salt, mineral, polymer, low molecular weight compound and combinations of same.

In some examples, the aqueous carrier comprises water, the latter constituting up to 80 wt % out of the total weight of the hydrogel. The remainder of the aqueous carrier comprising one of or combination of salts, minerals and/or polymers and optionally inert impurities.

In some examples, the aqueous carrier comprises said water and at least one cationic mineral.

In some examples, the cationic mineral comprises any one of combination of calcium and/or potassium. The cationic mineral can originate from the CAR, i.e. inherently present within the CAR powder from which the hydrogel is formed or can ne externally added to the CAR, at any stage during the formation of the hydrogel or after the hydrogel is formed.

In some examples, the cationic mineral is present or added in an amount that would initiate or promote hydrogel formation.

In some examples, the aqueous carrier comprises a water-soluble polyol(s). In some examples, the polyol is selected from the group consisting of glycerol, Maltitol, sorbitol, xylitol, erythritol, and isomalt and combinations of same.

In some examples, the polyol is or comprises at least glycerol

In some examples, the hydrogel comprises a cross linking agent.

The cross-linking agent can be a cationic mineral, as discussed hereinabove.

In some examples, the aqueous carrier comprises water.

In some examples, the aqueous carrier comprises water and a bulking agent.

In some examples, the aqueous carrier comprises water, a bulking agent and protein.

In some examples, the amount of water in the aqueous carrier is at least 50 wt % out of the total volume of the hydrogel.

In some examples, the aqueous carrier of the final hydrogel is the same as the rehydrating composition/medium.

The edible hydrogel can be provided in any physical form.

In some examples of the presently disclosed subject matter, the edible hydrogel is in a form of a film. In the context of the present disclosure, when referring to a film it is to be understood to define also the physical shape of the hydrogel having at least one dimension that is twice greater than at least one other dimension of the physical shape.

In some examples, the film is in a form of a layer, having a length (longitudinal dimension/direction) and/or width (being perpendicular to the length and defining with the length the film's plane) that are greater than the thickness or height thereof (perpendicular to the film's plane). This includes, for example, sheets, flat strands, flat strips etc. Thus, the “film” can be defined by a Cartesian coordinate system (X—length, Y—width, defining together the films horizontal plane, Z—thickness) and excludes any amorphous shapes.

In some examples, the edible film has a thickness of at most 5 mm; at times, at most 4 mm; at times at most 3 mm; at times at most 2 mm; at times at most 1 mm; at times at most 1 mm; at times at most 0.9 mm; at most 0.8 mm; at most 0.7 mm; at most 0.6 mm; at most 0.5 mm; at most 0.4 mm; at most 0.3 mm; at most 0.2 mm; at most 0.1 mm; at times, at most 0.05 mm or even at most 0.01 mm.

In some examples, the edible film has a thickness of between about 0.01 mm and 5 mm; at times, between 0.05 mm and 5 mm; at times, between 0.05 mm and 5 mm; at times, between 0.05 and 4 mm; at times, between 0.05 mm and 3 mm; at times between 0.1 mm and 5 mm; at times between abut 0.1 mm and 4 mm; at time between about 0.1 mm and 3 mm; at times between about 0.1 mm and 2 mm; at times between 0.2 mm and 5 mm; at times between 0.3 mm and 3 mm; at times, within any range between 0.5 mm and 5 mm. Any range within the range of about 0.01 mm and about 5 mm also forms part of the presently disclosed subject matter.

In some examples, the edible film has a length of at least 10 mm; at times, at least about 50 mm; at times, at least about 10 cm; at times, at least about 20 cm; at times, at least about 30 cm; at times, at least about 40 cm; at times, at least about 50 cm; at least about 60 cm; at least about 70 cm; at least about 80 cm; at least about 90 cm; In fact, the edible film can even reach a length of meters.

In some other examples, the hydrogel is in particulate form, this including spherical forms, amorphous particulates, flakes, and the like.

The presently disclosed hydrogel is uniquely strong and/or thermally stable. These physical properties are exhibited when the hydrogel comprises between about 50 wt % water and 80 wt % aqueous liquid. The hydrogel, with this liquid content, is characterized by one or more of the following features:

Storage Modulus (G′)—The hydrogel exhibits a storage modulus of at least 10 KPa within a wide temperature range as shown in Table 2 and Table 5A of the below non-limiting Examples. Storage modulus is a measure of how much force must be put into the sample in order to distort it.

In accordance with the present disclosure, Storage Modulus can be determined using a rotational rheometer (e.g. texture analyzer being the same or similar to TA1 HR 20 Discovery Hybrid Rheometer, ARES-G2, Advanced Peltier System (APS)) using 40 mm stainless steel, sandblasted plates and a strain range of 1%-10%, preferably about 10%, Axial force within a range of about 1N to about 10N, preferably about 1N, and frequency of 10 Hz.

In the context of the present disclosure, a hydrogel having a storage modulus of at least 10 KPa would be understood to be solid, and stiff/hard.

In some examples, the presently disclosed hydrogel has a storage modulus of at least 20 KPa, at times of at least 30 KPa; at times of at least 40 KPa; at times of at least 50 KPa; at times of at least 60 KPa; at times of at least 70 KPa; at times of at least 80 KPa when measured at a temperature of 50° C.

In some examples, the presently disclosed hydrogel has a storage modulus of between 10 KPa and 1,000 KPa, when measured at a temperature range of 25° C. and 70° C.; at times, within a range of 20 KPa and 1,000 KPa, when determined at a temperature range of about 25° C. and about 50° C.; or at times, within a range of 80 KPa and 1,000 KPa, at a temperature range of about 25° C. and about 50° C.

Tensile Strength (tensile stress at break)—The hydrogel exhibits a tensile strength (ultimate tensile strength) of at least 600 KPa, and preferably at least 2 MPa or at least 3 MPa, i.e. a maximum stress of 3 MPa before rupturing. The high tensile strength is exhibited in Tables 3A-3B and Table 5B of the non-limiting Examples that form an integral part of the presently disclosed subject matter. This ultimate tensile strength was at least twice higher than that of other hydrogel-forming polymers after the same type of treatment, thus supporting the superior firmness and resilience of the CAR-based hydrogels disclosed herein.

Tensile strength and tensile strain at break were determined by TA1 series texture analyzer with the test conditions including a load cell of 100N and a speed test of 20 mm/sec with a sample having dimensions of about 100 mm*20 mm and thickness of about 1.0 mm (herein Sample Type 1) or with a sample prepared according to ASTM D638 Type 1 (herein Sample Type 2).

In some examples, the hydrogel has a tensile strength of at least 600 KPa; at least 700 KPa; at least 800 KPa; at least 900 KPa; at least 1 MPa; at least 1.1 MPa; at least 1.2 MPa; at least 1.3 MPa; at least 1.4 MPa; at least 1.5 MPa; at least 1.6 MPa; at least 1.7 MPa; at least 1.8 MPa; at least 1.9 MPa; at least 2.0 MPa; at least 2.1 MPa; at least 2.2 MPa; at least 2.3 MPa; at least 2.4 MPa; at least 2.5 MPa; at least 2.5 MPa; at least 2.6 MPa; at least 2.7 MPa; at least 2.8 MPa; at least 2.9 MPa; at least 3.0 MPa; 3.1 MPa; at times of 3.2 MPa; at times of 3.3 MPa; at times of 3.4 MPa; at times of 3.5 MPa; at times of at least 3.6 MPa; at times of at least 3.7 MPa; at times of at least 3.8 MPa; at times of at least 3.9 MPa.

In some preferred examples, the hydrogel has a tensile strength of at least about 3 MPa.

In some examples, the hydrogel has a tensile strength of up to 30 MPa, or up to 20 MPa or up to 10 MPa.

Tensile Strain (strain at break, %)—The hydrogel exhibits a tensile strain at break of at least 15% at 25° C.; at times, of at least 16%, or even at least 17% at said temperature. As shown in the non-limiting examples, the values that were obtained with the CAR based hydrogel were much higher than that obtained with the other exemplified hydrogel forming polymers, such as Agar, and Alginate.

The presently disclosed subject matter is further supported by the non-limiting examples that show that the properties of the hydrogel are not limited to a specific CAR concentration and/or treatment duration and in fact using CAR content that is above 5% and/or shorter dehydration times provided edible hydrogels with the same advantageous physical properties.

The presently disclosed subject matter also provides a method for obtaining the presently disclosed hydrogel. The presently disclosed method comprises exposing or treating a native hydrogel comprising at least 5 wt % CAR in an aqueous medium to a dehydration process until obtaining a dehydrated hydrogel with up to 50% liquid content i.e. not more than 50% water remaining in the hydrogel, preferably not more than 45% water remaining in the hydrogel; or even preferably not more than 40% water remining in the hydrogel; or even not more than 35% water remaining in the hydrogel or even not more than 30% water remaining in the hydrogel; or even not more than 25% water remining in the hydrogel). The dehydrated hydrogel is then subjected to a rehydration process by exposing the dehydrated hydrogel to a rehydration medium.

In the context of the present disclosure, when referring to native hydrogel it is to be understood to denote the hydrogel per se comprising the hydrogel forming agent (be it a single agent or a combination of hydrogel forming agents, as described above with respect to the presently disclosed edible hydrogel) and the aqueous medium holding the hydrogel forming agents. The native hydrogel is typically at a gel state. In some examples of the presently disclosed method, when describing the processing steps applied onto the native hydrogel, it is to be understood to also encompass processing steps applied onto the hydrogel after being exposed to the anti-solvent treatment. For example, dehydration can be performed on the native hydrogel (the hydrogel forming material and water per se) as well as to the native hydrogel, after being exposed to an anti-solvent system.

In the context of the present disclosure, the native hydrogel is to be understood to refer to the product of mixing the hydrogel forming agent(s) in an aqueous medium. Such mixing typically results in the formation of a gel. Yet, in the context of the present disclosure, the native hydrogel may be in a form of a semi-solid, i.e. before the gel is completely formed or fully solidifies. Thus, when referring to the native hydrogel comprising at least 5 wt % CAR in an aqueous medium, it is to be understood to encompass a mixture in any degree of gelation.

In some examples of the presently disclosed method, prior to exposing the hydrogel to a dehydration process, it is subjected to an anti-solvent treatment. The anti-solvent treatment is not mandatory and yet was found to improve the properties of the resulting rehydrated hydrogel. Thus, in the context of the presently disclosed method, when referring to the dehydration process it is to be understood to refer to a process that is applied onto the native hydrogel or on the native hydrogel after being subjected to the anti-solvent treatment, as further described below.

The dehydration step can be performed by any technique available in the art. In some examples, dehydration is by heating the hydrogel (native or after anti-solvent treatment). In some examples, the dehydration is by heating at a temperature of at least 40° C.; or even at least 45° C.; or about 50° C., but not more than 70° C. for a time sufficient to reduce the liquid (mainly water) content to below 50%. In some examples, the dehydration is under conditions causing reduction of the liquid content to below 45%. In some examples, the dehydration is under conditions causing reduction of the liquid content to below 40%. In some examples, the dehydration is under conditions causing reduction of the liquid content to below 35%. In some examples, the dehydration is under conditions causing reduction of the liquid content to below 30%.

Dehydration can be achieved by placing the hydrogel within a drying oven set at a temperature of not more than 70° C., at times, not more than 60° C., at times, not more than 55° C., at times, about 50° C. In some examples, the dehydration involves circulation of air, to remove humidity. In some examples, the dehydration is for at least several hours, e.g. about 1 to 15 hours, about 2 to 12 hours, about 3 to 14 hours, about 5 to 13 hours, about 6 to 12 hours or for any time within the time window of 1 to 15 hours.

When requiring a hydrogel film, it can be formed on a film forming bed or in mold while controlling thickness (height dimension) of the hydrogel during the different treatment. This is achieved by pouring the native hydrogel, onto the film forming bed or placed as a thin laminate. The thickness of the hydrogel being formed would typically be equal or less than the eventually formed hydrogel film. In this connection, it is noted that the heating of the gel can be before placing the gel in the mold or on the film forming bed, or after said placement.

When requiring the hydrogel in particulate form, these can be formed by either grinding/chopping the dehydrated or rehydrated hydrogel film, or by a priori forming the native hydrogel in particulate form, e.g. as droplets on a bed, or by using an air jet nebulization of small sprayed droplets, or by the use of a mesh shaped mold.

The thus formed dehydrated hydrogel are then rehydrated within a rehydrating environment.

The dehydrated hydrogel can be defined/identified/characterized by the same tests used to characterize the hydrogel after rehydration. Specifically, the dehydrated hydrogel can be characterized by first transforming the dehydrated hydrogel into a hydrated state, i.e. into its rehydrated form (rehydration until the hydrogel holds between about 50 wt % and about 80 wt % water).

After applying the rehydration conditions, the hydrogel can be characterized by any one or combination of:
a storage modulus (G′) of at least 10 KPa within a temperature range of 25° C.-70° C.; as determined by applying on a disc sample formed from the rehydrated hydrogel the disc having dimensions of 40 mm*1 mm thick and analyzed by Rheometer (Discovery HR20, TA) when placed between 40 mm stainless steel, sandblasted parallel plates, a strain in the range of about 1% and about 10%, preferably about 10%, an axial force in the range between about 1N and about 10N, preferably about 1N, and at a frequency of 10 Hz
a tensile strength of at least 600 kPa as determined at 25° C. on a strip sample of said edible hydrogel, having dimensions of about 100 mm*20 mm and thickness of about 1.0 mm (referred to herein as Sample Type 1), or on a sample prepared according to ASTMD638 Type 1 (referred to herein as Sample Type 2), and
a tensile strain at break of at least 15% as determined at 25° C., on a strip sample of said edible hydrogel, having dimensions of about 100 mm*20 mm and thickness of about 1.0 mm (referred to herein as Sample Type 1) or on a sample prepared according to ASTMD638 Type 1 (referred to as Sample Type 2).

The parameters and conditions of performing the tensile strength and tensile strain tests are described hereinabove.

In some examples of the presently disclosed subject matter, the rehydrated hydrogel is characterized by at least two of the above characteristics, namely, at least two, at times all three of the storage modulus and/or the tensile strength and/or tensile strain.

In some examples, when the native hydrogel is subjected to an anti-solvent treatment, followed by dehydration, the dehydrated hydrogel can be stored As Is until further use or it can be further processed by exposing the same to a rehydration composition, at least to form therefrom the rehydrated hydrogel.

Thus, in the context of the present disclosure and for the sake of clarity, when referring to a dehydrated hydrogel it is to be understood to encompass a hydrogel containing up to 50 wt % water; and preferably between 30 wt % and 50 wt % water; while when referring to hydrated hydrogel it is to be understood to encompass a hydrogel holding between 50 wt % water and 80 wt % water.

The edible hydrogel can also be a rehydrated hydrogel, namely, holding between 50 wt % to 80 wt % water.

In some examples, the rehydrated hydrogel is obtained by placing the dehydrated hydrogel in a controlled humidity chamber.

In some examples, the rehydrated hydrogel is obtained by placing the dehydrated hydrogel in a rehydrating composition made of dough or gel or moisture containing food mass. This may include, for example, placing the hydrogel between layers of the food product or mixed with other components of the food product, which it is needs to reinforce, as further discussed below.

The rehydrated hydrogel can also be obtained by exposing or soaking or infusing, immersing, impregnating, or saturating, the dehydrated hydrogel to a rehydrating composition. The rehydrating composition or rehydrating environment can include any aqueous based medium that causes rehydration of the hydrogel. In some examples, the rehydrating composition is the same as the aqueous medium in which the CAR was initially dissolved (i.e. the aqueous medium in the native hydrogel).

In some other examples, the rehydrating composition is different from the aqueous medium in which the CAR was initially dissolved.

Being the same or different, the aqueous medium and the rehydrating composition comprise at least water.

In some examples, the aqueous medium and the rehydrating composition comprise a same or different cross-linking agent.

In some examples, the cross-linking agent is a cationic mineral, as described hereinabove. In some examples, the cross-linking agent comprises at least potassium, e.g. KCl.

In some examples, the cross-linking agent, e.g. KCl, is present within the hydrogel forming mixture and/or within the rehydrated hydrogel at a salt concentration of between 0.1M and 1M, typically, although not exclusively, at a water volume of about 70%.

At times, the cross-linking agent is present within the native hydrogel and/or within the rehydrated hydrogel at a salt concentration of between about 0.1M and 0.9M; at times, between 0.15M and 0.75M; at times, between 0.05M and 0.8M.

In some examples, any one of the aqueous medium and the rehydrating composition comprise a polyol. Examples of polyols that can be used as part of the solvent system include glycerol, Maltitol, sorbitol, xylitol, erythritol, and/or isomalt.

In some examples, the aqueous medium and the rehydrating composition are different.

In some examples, the rehydrated hydrogel is stored AS IS, or is further processed into an edible final product.

As noted hereinabove and below, the native hydrogel can be subjected to an anti-solvent system. In the context of the present disclosure, when referring to an “anti-solvent” of “anti-solvent system” it is to be understood to include any solvent that reduces solubility of the CAR within the aqueous medium in which it is held. In some examples, the adding or exposure of the native hydrogel to the anti-solvent initiates or promotes the conversion of the gel comprising the CAR in soluble form into a semi-solid (stiffer/harder/tougher) state.

In some examples, the treatment with the anti-solvent system comprises soaking or saturating or immersing or otherwise bringing the native hydrogel (at least partially in a gel state) in contact with an anti-solvent system.

In some examples, the exposure to an anti-solvent comprises saturating the native hydrogel to the anti-solvent system, in the presence of a cross-linking agent, e.g. the anti-solvent comprises alcohol and the cross-linking agent, e.g. KCl.

It is noted that cross linking agents can be added at any stage of the process of forming the hydrogel. It can be part of the CAR powder which is mixed with an aqueous medium (comprising or consisting of water), to thereby form the hydrogel forming mixture; it can be part of the aqueous medium; it can be added during the anti-solvent treatment/exposure; etc.

In some examples, the anti-solvent comprises ethanol.

In some examples, the alcohol treatment comprises exposing the native hydrogel to an ethanol system comprising a salt (as the cross linking, such as KCl).

In some examples, the salt or the KCl is at a concentration of between about 0.01M and 1M, at times, between about 0.05M and 0.75M, at times, between about 0.1M and 0.5M.

In some examples, the alcohol treatment is for a time sufficient to initiate solidification of the native hydrogel.

In some examples, the alcohol treatment is for a time period of 1 to several hours, e.g. 1-5 hours, or 1-4 hours or 1-3 hours.

The alcohol treatment of the anti solvent system takes place before the dehydration step.

In some examples, the above treatment with the anti-solvent system can be performed in a container and after the anti-solvent is added, the solidifying mixture is placed on the bed or within the mold. In some other examples, the mixture is placed on the bed or within a mold during the anti-solvent treatment. In yet some other examples, the mixture is placed on the bed or within a mold during the dehydration process.

The resulting edible hydrogel, be it in dehydrated state or in its rehydrated state, can be subjected to additional processing steps. In some examples, the resulting hydrogel is subjected to mechanical processing. Without being limited thereto, the mechanical processing can comprise any one or combination of pressing, role pressing, drawing, spinning and the like.

The edible hydrogel of the presently disclosed subject matter can be used in various food products, as a strengthening element, due to its high physical strength, as disclosed herein.

In some examples, the edible hydrogel is added as a reinforcing element within the food product. In order words, the disclosed edible hydrogel is used for improving at least texture of food products.

In some examples, the edible hydrogel is used for reinforcing/improving texture of non-animal derived alternative food products, e.g. plant based or cell based (cell cultured) alternative foods.

In some examples, the hydrogel is in a form of a film, placed between layers of the protein mass of a food product, e.g. during additive manufacturing of the multi-layered food product. In some examples, the additive manufacturing comprises 3D printing of the food product. The hydrogel film can thus be useful in reinforcing of whole meat slab analogues, steak analogues and the like.

In some other examples, the hydrogel is in particulate form, mixed with minced-like protein mass. This can be useful, e.g. in the manufacturing and reinforcing of plant-based hamburgers, kebabs, and the like.

Thus, the present disclosure also provides a food product comprising the edible hydrogel disclosed herein, in the form of films, particles and mixtures of same.

In some examples, the food product is a meat analogue product.

In some examples, the food product is a cheese analogue product.

In some examples, the edible hydrogel disclosed herein is suitable for use as edible food packaging, such as for stuffed foods, e.g. sausages. The disclosed edible hydrogel can also be used for changing the texture (e.g. toughening) of other foods, such as jams, tofu, noodles, dessert gels, jellies.

As used herein, the forms “a”, “an” and “the” include singular as well as plural references unless the context clearly dictates otherwise. For example, the term “a salt” includes one or more types of salts, e.g. for cross linking the hydrogel forming agent.

Further, as used herein, the term “comprising” is intended to mean that the composition include the recited components, i.e. at least CAR and water, but not excluding other elements, such as salts, mineral, polymers that may be inert or have a beneficiary effect on the formation of the hydrogel. The term “consisting essentially of” is used to define hydrogels or other compostions which include the recited elements but exclude other elements that may have an essential significance on the formation of the hydrogel with the defined properties. “Consisting of” shall thus mean excluding more than trace elements of other elements. Embodiments defined by each of these transition terms are within the scope of this invention. Similarly, when using the term “essentially” it is to be understood to cover also any minor deviations (as appreciated by those versed in the art) from the recited feature, as long as the deviation does not affect the functionality or critical properties of the presently disclosed subject matter, the critical properties being as claimed.

Further, all numerical values, e.g. when referring the amounts or ranges of the elements constituting the mixtures such as the hydrogel forming mixture comprising CAR, are approximations which are varied (+) or (−) by up to 20%, at times by up to 10% of from the stated values. It is to be understood, even if not always explicitly stated that all numerical designations are preceded by the term “about”.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### DETAILED DESCRIPTION OF NON-LIMITING EXAMPLES

### Example 1—κ-Carrageenan (κ-CAR) Film Production

κ-CAR (5%, CPKELCO WR-78) solution was prepared in a Thermomix device, heated to 90° C. for 15 minutes. The resulting “activated CAR” solution was poured over a clean surface and compressed with a heated metal surface to obtain a uniform film of 1 mm thickness, referred to hereinbelow as the “Native” CAR.

To produce thinner Native CAR films, the activated CAR solution is placed on top of a clean surface, heated to 90° C. and the solution is then smeared on the surface using a roller. The distance between the surface and the roll will determine the thickness of the film. By using this technique, films as thin as 0.01 mm can be prepared.

The film was then segmented into sample films, and each segment was subjected to a different treatment as defined below:

Anti-Solvent—Alcohol treatment of the segmented film in a bath of ethanol:water 1:1, in the presence of KCl 0.5M

Anti-solvent/Dehydration-Alcohol treatment followed by dehydration of the segmented film by heating to 50° C. for at least 12 hours.

Dehydration/Rehydration—Dehydration by heating the Native CAR to 50° C. and then rehydration by soaking the dehydrated segmented sample film in rehydration compositions as detailed below. The time needed for dehydration depended on the thickness of the film. For a film of 1 mm, dehydration was for at least 12 hours.

Combined—a film formed by the treatment of the Native CAR with the following steps (a) alcohol (“Anti-Solvent”) followed by (b) Dehydration of the alcohol treated film, the dehydration was performed by heating to 50° C. for several hours (depending, e.g. on thickness of film) and then subjecting to (c) Rehydration of the dehydrated film by soaking in a rehydration composition.

Control—the control group where the segmented film with no treatment (“Native” CAR).

Rehydration composition—two types of rehydration compositions were used:
Rehydration composition A—comprising about 55%-70% water, about 13%-15% TVP soaked in water, about 25% other plant-based protein, about 1% Methylcellulose.
Rehydration composition B—comprising about 15%-25% TVP soaked in water, about 3%-8% plant-based oil, about 55%-70% water, about 3%-8% plant-based protein, about 3% Methylcellulose

The two rehydration compositions had a viscous, semi-solid texture, similar to dough, allowing the use of the same as in a form of pliable, layers.

The physical and rheological characteristics of each treatment sample were investigated using the following techniques:

### Thermogravimetric Analysis (TGA)

Each treated segmented film was analyzed in TGA instrument (Perkin Elmer) @10° C./min to determine water content and other volatiles.

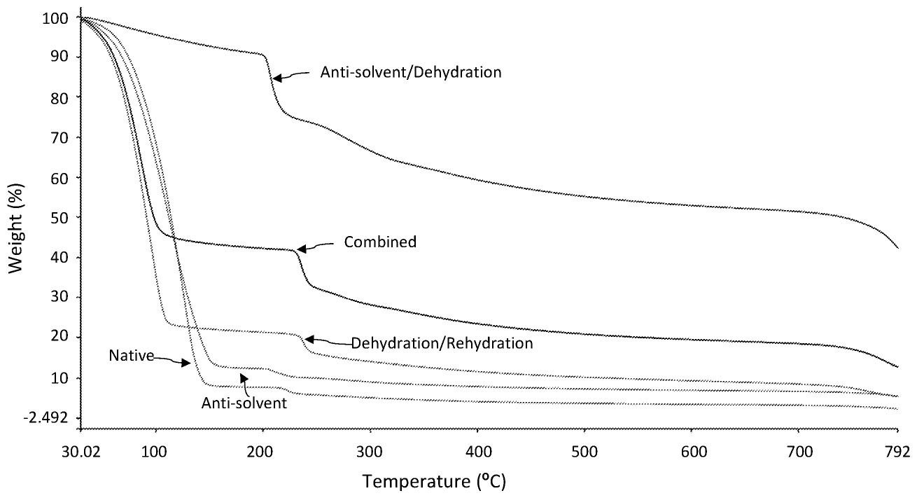

FIG. 1 shows the TGA of the different treated films.

Specifically, FIG. 1 shows that the Native film (i.e. no treatment) and the ethanol treated film, water is bound to the CAR molecules and evaporated at temperatures between 100° C. and 150° C.

The Anti-Solvent/Dehydration film had approximately 10% water, as shown by the respective arrow.

After rehydration, i.e. in the Dehydration/Rehydration film, the water soaked into the film behaved like free water, namely, the Dehydration/Rehydration CAR film was unable to hold water. Without being bound by theory, the water evaporation in the Native (untreated CAR film) is >100° C., whereas in a Dehydrated/Rehydrated film water evaporated already at ~100° C. This led to a conclusion that in the Native and Anti-solvent treated films water molecules are bound, thus requiring higher temperatures for evaporation, while the water molecules in the Dehydrated/Rehydrated film and in the Combined film are unbound, thus behaving (evaporating) like free water.

The results also show that in the Native (untreated) and the Anti-solvent films CAR molecules burn at ~200° C. while in the Anti-Solvent/Dehydrated film, CAR molecules burn at ~250° C. Thus, further, without being bound by theory, it seems that dehydration created strong bonds between the CAR molecules and as a result a dehydrated film was more stable under conditions at which the Native film or the Anti-solvent film disintegrated.

Table 1 summarizes the weight % of CAR and weight % of water in each tested film. The % Other in Table 1 relates to residues at the end of the TGA measurements and are assumed to include any one of salts, minerals, polymers or impurities.

TABLE 1
Film Composition

| Sample | CAR (%) | Water (%) | % Other |
|---|---|---|---|
| Native | 4.12% | 91.65% | 4.23 |
| Anti-Solvent | 8.09% | 86.45% | 5.45 |
| Anti-Solvent/Dehydrated | 32.54% | 9.35% | 58.11 |
| Dehydrated/Rehydrated in A* | 13.82% | 76.78% | 9.4 |
| Combined | 13.07% | 54.33% | 32.6 |

*rehydration in rehydration composition A

Table 1 shows that in the Anti-solvent/Dehydrated film, the amount of water is about 10%, while after rehydration, the amount of water does not (and cannot) return to its level as in the Native film or after only the Anti-Solvent treatment. Rehydration of the dehydrated film allowed for up to 80% water content.

### Storage Modulus Measurements

Temperature dependent storage modulus (Temperature Sweep Test) of different films were tested.

Specifically, films were produced using, as the hydrogel forming material, Methylcellulose, Agar, κ-CAR, Konjac or Alginate. Each film was prepared by dissolving 5% of the indicated hydrogel forming material in water and then either tested in its Native form (“Native”), or, when indicated, after an Anti-Solvent treatment or Anti-Solvent treatment followed by Dehydration and Rehydration (“Combined”). In some films, other ingredients were added, as indicated below, including Gellan and/or Glycerol.

The Storage Modulus test was performed on discs of 40 mm in diameter and 1 mm thick, and analyzed by Rheometer (Discovery HR20, TA) using 40 mm stainless steel, sandblasted parallel plates, during which each film was subjected to Grips axial force (1N), oscillation strain of 10%, and frequency of 10 Hz. The tested temperature range was 25° C.-70° C., which also provided information regarding each films' melting temperature and plasticity.

Table 2 shows Temperature dependent Storage Modulus of the tested films.

TABLE 2
Storage Modulus

| | | Storage Modulus (KPa) | | | |
|---|---|---|---|---|---|
| | wt % of | Temperature | | | |
| Material | Material | 25° C. | 50° C. | 70° C. | Comment |
| Methyl Cellulose | 5% | 1.19 | 1.41 | 23.76 | Storage modulus (strength) |
| | | | | | increased with temperature |
| Agar | 5% | 26.12 | 30.02 | 12.66 | At 70° C. the film melted |
| κ-CAR | 5% | 9.17 | 5.04 | 1.70 | At 70° C. the film melted |
| Konjac | 5% | 2.70 | 2.09 | 2.12 | Low storage modulus which |
| | | | | | is not affected by temperature |
| | | | | | change |
| Alginate | 5% | 53.77 | 55.08 | 50.07 | Medium storage modulus |
| | | | | | which is not affected by |
| | | | | | temperature change |
| CAR - Anti- | 5% | 5.47 | 10.79 | 7.68 | Low storage modulus which |
| Solvent | | | | | is very mildly affected by |
| | | | | | temperature change |
| Agar - Anti- | 5% | 13.86 | 16.28 | 7.96 | At 70° C. the film melted |
| Solvent | | | | | |
| CAR dehydration/ | 5% | 14.86 | 99.13 | 5.16 | |
| rehydration | | | | | |
| CAR - Combined | 5% | 189.25 | 335.23 | 252.45 | High storage modulus |
| | | | | | which is not affected by |
| | | | | | temperature change |
| Agar - Combined | 5% | 7.83 | 18.31 | 20.45 | Storage modulus increases |
| | | | | | with temperature, although |
| | | | | | mildly |

The results show that when using κ-CAR as the hydrogel forming polymer and subjecting the hydrogel film formed therefrom to at least rehydration followed by dehydration a film with high storage modulus (above 10 kPa) is obtain, that is not affected by the change in temperature. It was thus concluded that the dehydration followed by the rehydration treatment are the minimally essential steps required for obtaining a significant increase in the strength of the CAR-based film as well as its thermal stability, as confirmed by the TGA results. The storage modulus is significantly improved with before the dehydration, the hydrogel (the “active K-CAR”) is subjected to the anti-solvent treatment.

### Tensile Test (Stress/Strain Test)

Tensile Tests were s conducted, at room temperature (~22° C.) and the tensile strain at break (%) and tensile stress (KPa) results are provided in Table 3A (films prepared with rehydration composition A) and Table 3B (films prepared with rehydration composition B). unless otherwise states, all samples were prepared with 5% hydrogel forming material.

The data presented in Table 3A was obtained using a TA1 Series Texture Analysis machine (LLOYD TA1), using a load cell of 100N with TG74: adjustable Rear Face Vice Grip 5 kN-1124 lbf. Test speed was 20 mm/sec. The test was applied on different film samples (CAR, Gellan, Agar, Alginate), each containing 5% of the hydrogel polymer in water, the film having a height of 100 mm (50 mm gauge), a width of 20 mm and a thickness of 1 mm.

The data presented in Table 3B was obtained TPA apparatus, however the sample prepared according to ASTM D638 Type 1 (herein Sample Type 2). For rehydration part, the dehydrated films were sandwiched between two layers of the dough like rehydration composition B for at least 12 hours.

TABLE 3A
Tensile Strain/Stress of films prepared
with rehydration composition A

| | Strain at | Stress at | |
|---|---|---|---|
| Film | Break (%) | Break (KPa) | Comments |
| CAR | 45.10 | 204.86 | ~45% elongation |
| (Native) | | | before break. |
| | | | Medium |
| | | | resistance to |
| | | | stress |
| Gellan | 92.35 | 68.99 | More elastic than |
| (Native) | | | CAR but less |
| | | | resistant to stress |
| Agar | 9.06 | 26.69 | Non-elastic and |
| (Native) | | | with no |
| | | | resistance to |
| | | | stress |
| CAR | 40.30 | 2,370.51 | 40% elongation |
| Dehydration/ | | | before break |
| Rehydration | | | Highly resistant |
| | | | to stress |
| Agar | 25.53 | 0.18 | Slightly elastic, |
| Dehydration/ | | | no resistance to |
| Rehydration | | | stress |
| Alginate | 10.45 | 90.37 | Non-elastic, |
| (Native) | | | slightly resistant |
| | | | to stress |
| CAR- Anti- | 73.77 | 619.49 | Very elastic and |
| Solvent | | | resistant to stress |
| CAR-Combined | 17.81 | 3,025.06 | Slightly elastic, |
| | | | highly resistant |
| | | | to stress |
| Agar-Anti- | 12.47 | 0.02 | Slightly elastic, |
| Solvent | | | no resistance to |
| | | | stress |
| Agar - | 19.55 | 0.31 | Slightly elastic, |
| Combined | | | no resistance to |
| | | | stress |

TABLE 3B
Tensile Strain/Stress of films prepared
with rehydration Composition B

| | Strain at | Stress at |
|---|---|---|
| Film | Break (%) | Break (KPa) |
| CAR (Native) | 61.13 | 88.74 |
| CAR 5% Dehydration/ | 59.15 | 1081.8 |
| Rehydration | | |
| CAR Anti-Solvent | 112.066 | 938.77 |
| CAR Combined | 101.15 | 2188.52 |

As observed, while the Native “CAR” film was found to be the weakest amongst the CAR containing films, breaking already at a stress of approximately 200 KPa, All CAR films had a higher resistance to stress when compared to the films from other polymers. While the Anti-Solvent CAR film showed a tensile strength of between 600 KPa and 900 kPa, being a bit higher than that of the Native CAR film, the CAR Dehydration/Rehydration film and CAR-Combined film were superior in terms of their tensile strength and breaking at stress of over 2000 KPa, for the Dehydration/Rehydration film (i.e. without the Anti-Solvent treatment), and even over 3000 KPa for the Combined film (Anti-solvent treatment+dehydration/rehydration treatment). The beneficial effect of the dehydration and rehydration was independent on the type of rehydration composition as evident from the superior strength exhibited in Table 3A, Table 3B and Table 5B with the Dehydration/Rehydration or the Combined films.

These results support the preference of a film comprising at least CAR and that undergoes at least the dehydration followed by rehydration for use, inter alia, as a strength enhancer (i.e. reinforcing films).

It was thus concluded that the sequential Dehydrating/Rehydrating treatments of the CAR film are essential for increasing the strength of the film.

The tested films were also analyzed for hydrogel forming material content and water content after the indicated treatment (rehydration composition A was used) and the results are provided in Table 4:

TABLE 4
CAR % and water % after the indicated treatment

| | | % CAR in | % Water in |
|---|---|---|---|
| Film | Treatment | final film | final film |
| 5% CAR | Native | 4.96% | 91.56% |
| | Dehydration/ | 13.82% | 76.78% |
| | Rehydration | | |
| | Combined | 13.07% | 54.33% |
| | Anti-solvent/ | 32.54% | 9.35% |
| | Dehydration | | |
| 5% CAR + 5% | Native | 5.01% | 89.97% |
| coconut oil | Dehydration/ | 13.24% | 73.52% |
| | Rehydration | | |
| 5% CAR + 10% | Native | 5.05% | 84.84% |
| coconut oil | Dehydration/ | 14.44% | 56.69% |
| | Rehydration | | |
| | Anti-solvent/ | 29.78% | 10.67% |
| | Dehydration | | |
| | Combined | 13.64% | 59.09% |
| 5% CAR + 5% | Native | 4.93% | 90.15% |
| pectin | Dehydration/ | 13.29% | 73.42% |
| | Rehydration | | |
| 5% CAR + 5% | Native | 5.28% | 89.44% |
| Gellan LT 100 | Dehydration/ | 12.64% | 74.71% |
| | Rehydration | | |
| 5% CAR + 5% | Native | 5.18% | 89.65% |
| Methyl cellulose | Dehydration/ | 10.38% | 79.24% |
| | Rehydration | | |

### Example 4—Films with Different CAR Concentration

The formulations for these tests were created as described above but with different κ-CAR initial concentrations (in the Native CAR).

Rehydration was performed with rehydration composition B.

Table 5A provide Storage Modulus determined in a test performed on discs of 40 mm in diameter and 1 mm thick, and analyzed by Rheometer (Discovery HR20, TA) using 40 mm stainless steel, sandblasted parallel plates, during which each film was subjected to Grips axial force (1N), oscillation strain of 10%, and frequency of 10 Hz. The tested temperature range can be 25° C.-70° C.

Table 5B provide tensile strength results with films formed with rehydration composition B and tested using TPA apparatus, under the conditions described above, and with the test samples created according to ASTM D638 Type 1 (herein referred to as Sample Type 2).

TABLE 5A
Storage Modulus of films formed with rehydration composition B

| | | Storage Modulus | | |
|---|---|---|---|---|
| Film | % | 25° C. | 50° C. | 70° C. |
| κ-CAR Native | 3% | 1.94 | 6.76 | 4.15 |
| κ-CAR - Anti-Solvent | 3% | 13.29 | 5.84 | 1.74 |
| κ-CAR dehydration/rehydration | 3% | 76.60 | 124.75 | 40.41 |
| without anti-solvent | | | | |
| κ-CAR - combined | 3% | 10.59 | 16.89 | 18.26 |
| κ-CAR Native | 7% | 15.69 | 10.52 | 3.31 |
| κ-CAR - Anti-Solvent | 7% | 37.4 | 15.52 | 8.47 |
| κ-CAR - dehydration/rehydration | 7% | 125.20 | 200.80 | 426.89 |
| κ-CAR - combined | 7% | 129.78 | 208.08 | 12.91 |
| κ-CAR Native | 9% | 5.93 | 8.75 | 7.35 |
| κ-CAR - Anti-Solvent | 9% | 460.23 | 653.93 | 616.23 |
| κ-CAR - dehydration/rehydration | 9% | 179.74 | 92.57 | 19.97 |
| κ-CAR - combined | 9% | 804.65 | 580.46 | 110.77 |

TABLE 5B
Strain/Stress strength of films formed with rehydration composition B

| Film | | 3% | 5%* | 7% | 9% |
|---|---|---|---|---|---|
| Native | Strain at break (%) | 60.71 | 61.13 | 101.31 | 104.53 |
| | Stress at break (KPa) | 55.06 | 88.74 | 222.91 | 355.63 |
| Anti-Solvent | Strain at break (%) | 127.38 | 112.066 | 274.35 | 237.82 |
| | Stress at break (KPa) | 690.46 | 938.77 | 1305.12 | 2743.35 |
| Dehydration/ | Strain at break (%) | 49.43 | 59.15 | 84.66 | 106.21 |
| Rehydration | Stress at break (KPa) | 935.47 | 1081.8 | 1382.54 | 1345.47 |
| Combined | Strain at break (%) | 57.1 | 101.15 | 101.95 | 233.99 |
| | Stress at break (KPa) | 1778.88 | 2188.52 | 948.35 | 2651.055 |

*Same as in Table 3B

The results also show that the high storage modulus and high strain at break (%) and stress at break are obtained with different concentrations of κ-CAR, thus, not limiting to only 5% CAR.

1-46. (canceled)

47. An edible hydrogel, comprising:
carrageenan (CAR); and
an aqueous carrier comprising water;
wherein said water constitutes up to 80 wt % out of a total volume of the hydrogel; and
wherein, when said edible hydrogel has between 50 wt % and 80 wt % water content, the edible hydrogel exhibiting:
CAR content of at least 5 wt % out of a total volume of the hydrogel;
a storage modulus (G′) of at least about 10 KPa within a temperature range of 25° C.-70° C.;
tensile strength of at least about 600 kPa as determined at 25° C.; and
tensile strain at break of at least about 15% as determined at 25° C.

48. The edible hydrogel of claim 47, wherein said CAR is κ-CAR.

49. The edible hydrogel of claim 47, wherein the CAR content is between 7% to 15% CAR.

50. The edible hydrogel of claim 47, being a dehydrated hydrogel with a liquid content of up to 30% out of a total weight of said dehydrated hydrogel.

51. The edible hydrogel of claim 47, being a rehydrated hydrogel with a liquid content of between 50% to 80% out of a total weight of said dehydrated hydrogel.

52. The edible hydrogel of claim 51, being characterized by at least one of the following properties:
a storage modulus (G′) of at least 80 KPa at a temperature of about 50° C.;
a tensile strength of at least 1 MPa;
a tensile strength of at least 3 MPa;
a tensile strain at break of at least 15%; or
a shape definable by a length and a width, the length being at least 10 m.

53. The edible hydrogel of claim 47, having a shape definable by a length and a width, the length being at least 10 mm.

54. The edible hydrogel of claim 47, being in a form of a film.

55. The edible hydrogel of claim 47, being in a form of a film that is defined by a length, width, and a thickness, wherein the thickness is at most 5 mm and the wherein the length is at least twice the film's thickness.

56. The edible hydrogel of claim 47, being in particulate form.

57. A method of producing an edible hydrogel, the method comprising:
treating a native hydrogel comprising at least 5 wt % CAR and an aqueous medium, said treating includes:
(a) subjecting the native hydrogel to a dehydration process until obtaining a dehydrated hydrogel with up to 50 wt % liquid content; and
(b) rehydrating the dehydrated hydrogel by exposing the dehydrated hydrogel to a rehydrating composition.

58. The method of claim 57, wherein said dehydration process comprises heating the native hydrogel until reaching a dehydrated hydrogel with up to 30% liquid content.

59. The method of claim 57, wherein said rehydrating of the dehydrated hydrogel comprises exposing the dehydrated hydrogel to a rehydrating composition to obtain a rehydrated hydrogel with a water content of up to 80 wt %.

60. The method of claim 57, comprising treating the native hydrogel with an anti-solvent system prior to said dehydration.

61. The method of claim 57, wherein said anti-solvent system comprises an alcohol.

62. The method of claim 57, comprising saturating the native hydrogel with the anti-solvent system.

63. A method of producing an edible hydrogel, the method comprising:
treating a native hydrogel comprising at least 5 wt % CAR and an aqueous medium, said treating includes:
(a) subjecting the native hydrogel to an anti-solvent system to obtain a solidifying native hydrogel; and
(b) subjecting the solidifying native hydrogel to a dehydration process until obtaining a dehydrated hydrogel with up to 50 wt % liquid content.

64. The method of claim 63, wherein said anti-solvent system comprises alcohol.

65. The method of claim 64, wherein said alcohol comprises ethanol.

66. The method of claim 63, comprising saturating the native hydrogel with the anti-solvent system.

67. The method of claim 63, wherein said anti-solvent system comprises an alcohol.

68. An edible hydrogel obtained or obtainable by the method of claim 57.

69. An edible hydrogel obtained or obtainable by the method of claim 63.

70. A food product comprising the edible hydrogel of claim 47.

71. A food product comprising the edible hydrogel of claim 68.

72. A food product comprising the edible hydrogel of claim 69.

73. The food product of claim 70, being a meat analogue product.

74. The food product of claim 71, being a meat analogue product.

75. The food product of claim 72, being a meat analogue product.
